(19) United States
(12) Patent Application Publication
(10) Pub. No.: US 2012/0298937 A1
(43) Pub. Date: Nov. 29, 2012

(54) MULTIDIMENSIONAL POSITIONING SYSTEM AND METHOD

(75) Inventor: Scott FISHER, Las Vegas, NV (US)

(73) Assignee: FTSI, LLC, Las Vegas, NV (US)

(21) Appl. No.: 13/476,432

(22) Filed: May 21, 2012

Related U.S. Application Data
(60) Provisional application No. 61/488,993, filed on May 23, 2011.

(51) Int. Cl. B66D 1/36

(52) U.S. Cl. 254/283

(57) ABSTRACT

A multidimensional positioning system including a first block assembly including a fixed first block portion and a moveable second block portion. A first travel cable is arranged on pulleys operatively connected to the first block portion, the second block portion and a predetermined location. The first travel cable is affixed to a base supporting a load. A first travel drive is operatively connected to the first travel cable to facilitate movement of the base in a second travel direction. A first lift drive is arranged and disposed to provide movement of the second block portion relative to the first block portion to selectively alter the length of the first travel cable in a working space and selectively move the base in a first travel direction.

### FIELD OF THE INVENTION

The invention is generally related to a positioning system and method for positioning a load. More particularly, the disclosure includes a system and method for positioning a load using cables arranged to provide multidimensional movement, particularly over large distances.

### BACKGROUND OF THE INVENTION

When presenting events such as concerts, sporting events, outdoor events or theatre productions, winches, pulleys and other equipment are commonly used for support, movement and manipulation of performers and various equipment, such as, cameras, lighting, sound, scenery and props. Cable systems having motorized winches have been used to move equipment and performers via cables during such productions.

Cable systems that currently exist for positioning loads in large venues provide movement for the loads generally in a limited range of motion, for example, the motion is generally limited to a horizontal or a vertical movement. There currently remains a need in the industry to provide two-dimensional or three-dimensional load positioning in large venues.

In addition, winch and cable systems have a limited lift capability, which is easily exceeded when cables are extended over long distances or have large loads mounted thereon. With limited lift capabilities, the winches are unable to provide movement over long distances or have limited directions of movement.

What is needed is a method and apparatus that provides a two-dimensional or three-dimensional positioning system for use in large venues.

### SUMMARY OF THE INVENTION

An embodiment of the present disclosure includes a system that provides a multidimensional range of motion of a load over a large distance by use of a second block portion that alters the amount of travel cable in a working space between a first block portion and a pulley mounted at a distance from the first block portion.

Another embodiment includes a multidimensional positioning system including a first block assembly including a fixed first block portion and a moveable second block portion. A first travel cable is arranged on pulleys operatively connected to the first block portion, the second block portion and a predetermined location. The first travel cable is affixed to a base supporting a load. A first travel drive is operatively connected to the first travel cable to facilitate movement of the base in a second travel direction. A first lift drive is arranged and disposed to provide movement of the second block portion relative to the first block portion to selectively alter the length of the first travel cable in a working space and selectively move the base in a first travel direction.

Another embodiment includes a multidimensional positioning block assembly including a first block assembly and a second block assembly each comprising a fixed first block portion and a moveable second block portion. A first travel cable is arranged on pulleys operatively connected to the first block portion of the first block assembly, the second block portion of the first block assembly, and a predetermined location. The first travel cable is further affixed to a base supporting a load. A second travel cable is arranged on pulleys operatively connected to the first block portion of the second block assembly, the second block portion of the second block assembly, and the predetermined location. The second travel cable is further affixed to the base supporting the load. A first lift drive is arranged and disposed to provide movement of the second block portion of the first block assembly relative to the first block portion of the first block assembly to selectively alter the length of the first travel cable in a working space and selectively move the base in a first travel direction. A second lift drive is arranged and disposed to provide movement of the second block portion of the second block assembly relative to the first block portion of the second block assembly to selectively alter the length of the second travel cable in the working space. A selective rate and/or magnitude of length alteration of the second travel cable in the working space by the second lift drive relative to a selective rate and/or magnitude of length alteration of the first travel cable in the working space by the first lift drive results in selective movement of the base in the first travel direction and/or a third travel direction.

Other embodiments include a control system and/or process corresponding to the disclosed system.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a schematic elevational view of an exemplary multidimensional positioning system according to the disclosure.

FIG. 2 shows a schematic top view of an exemplary multidimensional positioning system according to the disclosure.

Wherever possible, the same reference numbers will be used throughout the drawings to represent the same parts.

### DETAILED DESCRIPTION OF THE INVENTION

Provided is a system and method for positioning a load using cables arranged to provide multidimensional movement, particularly over large distances. What follows are exemplary embodiments.

An advantage of embodiments of the present disclosure includes a capability of selective combination of movement of a load in the horizontal direction, vertical direction and the lateral direction permitting movement and positioning in two-dimensions or three-dimensions within a working space.

Another advantage of embodiments of the present disclosure includes capability of multidimensional positioning and movement with a compact rig that does not require a significantly large footprint.

Still another advantage of embodiments of the present disclosure include the capability of simple, rapid assembly or installation that requires little skill or training.

Still another advantage of embodiment of the present disclosure includes the capability of providing images from a camera, particularly video from a variety of angles and positions, particularly for indoor or outdoor events having a large venue.

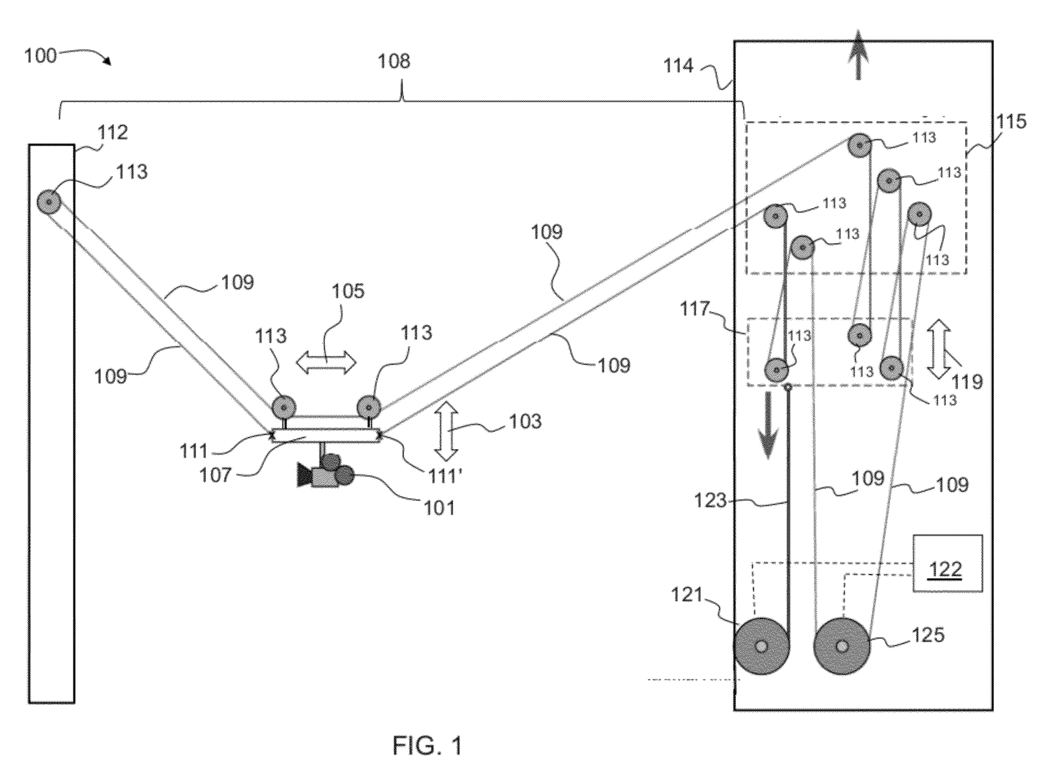

FIG. 1 shows a schematic view of a multidimensional positioning system 100, capable of positioning a load 101. In one embodiment, the load 101 is a camera or camera assembly. A camera and camera assembly include the camera itself, as well as associated equipment, such as batteries, transmitters, support structures, positioning or orienting systems, as well as control systems for providing tilt, roll and pan axes of motion, as desired. The camera may be powered by batteries or by wires. In addition, the camera may be controlled wired or wireless signals. In other embodiments, suitable loads are cargo, equipment, lighting assemblies, personnel or other movable or fixed load. The positioning of the load is accomplished along a first travel direction 103 or a second travel direction 105. In one embodiment, the first travel direction 103 and the second travel direction 105 refer to a vertical travel direction and a horizontal travel direction, respectively. The load 101 is mounted on a base 107, sometimes referred to as a sled, which is moved in the first travel direction 103 and second travel direction 105 by a travel cable 109 within a working space 108. The travel cable 109 is an elongate support device capable of supporting weight and being stored and driven on a winch. Suitable structures for use as travel cable 109 include, but are not limited to, a wire, cable, rope, tape or other structure capable of supporting weight. The travel cable 109 may be synthetic or non-synthetic material. Suitable materials for travel cable 109 may be a metal, polymer or other suitable high strength material of construction. In other embodiments, the travel cable 109 includes power or signal wires either integrated into the travel cable 109, adjacent to the travel cable 109 or run parallel to the travel cable 109 in order to provide power and/or control to the camera or other devices present as load 101. In one embodiment, one or more of the cables 109 are configured for transmitting signals (for example, through electrical signals). For example, in one embodiment, the cable(s) 109 include fiber-optic interiors with a durable exterior (for example, a flexible polymeric coating or a flexible metal coating). In one embodiment, one or more of the cables 109 includes an aramid fiber (for example, a polyimide fiber). In one embodiment, one or more of the cables 109 are steel cables and/or are of a gauge capable of supporting up to about 600 pounds on a single cable. In another embodiment, one or more of the cables 109 are braided Kevlar-jacketed. In one embodiment, the cables 109 within the system 100 include different materials permitting the cables to include various features. For example, in one embodiment, one of the cables 109 is configured for transmitting a signal, but another one of the cables 109 is a steel cable. In this embodiment, costs of including multiple cables 109 capable of transmitting a signal can be avoided and additional strength and/or stability can be achieved.

The travel cable 109 is attached to the base 107 at attachment points 111 and 111′ at opposite ends of the base 107. The cable 109 is connected to the attachment points 111 by any suitable mechanism. Suitable mechanisms include, but are not limited to, loop and closed-hook mechanisms, connectors guided by magnets for alignment, bolts or other fasteners, and cable splices. In addition, one or more pulleys 113 are mounted on base 107 and rollably support base 107 on travel cable 109. Pulleys 113 are preferably conventional pulley structures or other devices capable of rollably or slidably supporting a cable, wire or rope.

As shown in FIG. 1, the travel cable 109 extends from attachment point 111 to a pulley 113 mounted at a predetermined location. The pulley 113 mounted at the predetermined location is supportably mounted and is capable of supporting the base 107, load 101, and travel cable 109 at various angles, as the base 107 and the load 101 are moved. For example, the pulleys 113 may be mounted on a support structure 112, such as a truss, a fixed body, a non-fixed body, or other structure capable of supporting pulley 113. From the pulley 113, the travel cable 109 extends to the one or more pulleys 113 on base 107, wherein the pulleys 113 are rollably supported by travel cable 109. While, in one embodiment, at least one of the pulleys 113 operatively connected to the base 107 are free-rolling pulleys, in another embodiment, a brake, motor and/or other rotation facilitating or retarding device may be provided to at least one of the pulleys 113 operatively connected to base 107 to provide additional control for positioning the base 107 and load 101.

From the base 107, the travel cable 109 extends to a block assembly 114. The block assembly 114 includes a first block portion 115 and a second block portion 117. The travel cable extends from the base 107 to the first block portion 115 or head block wherein the travel cable 109 is rollably supported by one or more pulleys 113. The working space 108 is the area in which the base is permitted to move and is defined as being between the first block portion 115 and the pulley 113 mounted at the predetermined location, such as support structure 112. The distance between the first block portion 115 and the pulley mounted at the predetermined location may be large. For example, the distance between the first block portion 115 and the predetermined location may be greater than 100 feet, greater than 500 feet, greater than 1000 feet, or greater than 2500 feet. The working space 108 represents the area in which the travel cable hangs, suspends or otherwise extends to the base 107 at various angles from the first block portion 115 and the pulleys 113 mounted at the predetermined location. The first block portion 115 is a structure, such as a truss or other support device, which includes a series of one or more pulleys 113 preferably mounted in a fixed position thereon. The travel cable 109 extends from the first block portion 115 to a second block portion 117 or lift block wherein the travel cable 109 is rollably guided on one or more pulleys 113.

While, in one embodiment, at least one of the pulleys 113 at a predetermined location and the pulleys 113 operatively connected to the first block portion 115 and second block portion 117 is a free-rolling pulley, in another embodiment, a brake, motor or other rotation facilitating and/or retarding device may be provided to at least one of the pulleys. The second block portion 117 is a structure, such as a truss or other support device that is arranged and disposed such that the second block portion 117 is permitted to move in a lift direction 119. Movement in the lift direction 119 changes the displacement or the distance between the first block portion 115 and the second block portion 117. In one embodiment, lift direction 119 is oriented in generally the same direction as first travel direction 103. In another embodiment, the lift direction 119 is oriented in a different direction, such as at a predetermined angle, than the first travel direction. In addition, the amount of displacement of the base 107 and the second block portion 117 may be different or the same relative to each other. The amount of vertical displacement of the second block portion 117 relative to the amount of vertical displacement of the base 107 is dependent upon the arrangement of pulleys 113 operatively connected to the first block portion 115 and the second block portion 117. To facilitate the movement of the second block portion 117 in the lift direction 119, the second block portion may be mounted on rails or other guide structure or may be free standing.

To provide the motion for the second block portion 117, a lift drive 121 retracts or extends a lift cable 123 that is attached to the second block portion 117. The lift cable 123 may be attached to the second block portion 117 in any suitable manner known in the art for attaching cables to structures. The lift cable 123 may include, but is not limited to, a wire, cable, rope, tape or other structure capable of supporting weight. The lift cable 123 may be synthetic or non-synthetic material. Suitable materials for lift cable 123 may be a metal, polymer or other suitable high strength material of construction. The lift cable 123 may be the same or different material than the travel cable 109. For example, the travel cable 109 may be a lightweight, high strength material, such as polyimide fiber, while the lift cable may be a high strength, less expensive material, such as braided steel cable. The lift drive 121 may be any suitable device capable of providing a force on second block portion 117 sufficient to provide movement of second block portion 117 in lift direction 119. A suitable lift drive 121 is a powered winch having a drum or other device capable of retaining and retracting/deploying cable.

The travel cable 109 extends from the first block portion 115 to a travel drive 125. Suitable travel drives 125 include endless/friction rotation drives, winches and other devices capable of retaining and driving the travel cable 109.

From the travel drive 125, the travel cable 109 extends to the first block portion 115 and the second block portion 117. From the first block portion 115, the travel cable 109 extends to the base 107 and attaches at attachment point 111′. The arrangement and number of pulleys 113 operatively connected to the first block portion 115 and the second block portion 117 alters the force necessary to move the second block portion 117 relative to the first block portion 115. For example, a larger number of pulleys 113 operatively connected to the first block portion 115 and the second block portion 117 allows a reduced amount of force to draw the second block portion 117 downward along lift direction 119. The block assembly 114 can be arranged in a compact space, wherein the assembly may be mounted on a truck, platform or other structure that can be loaded easily and/or moved. The footprint or space required for installation of block assembly 114 is small and can be placed into non-utilized or under-utilized spaces at the desired venue. For example, in one embodiment, the block assembly 114 is loaded onto a truck, such as a flatbed truck or a compact, transportable skid.

As the second block portion 117 is moved along lift direction 119, the base 107 and the load 101 is likewise moved upward or downward along first travel direction 103. The amount of displacement that occurs along first travel direction 103 depends on factors, such as the length of the travel cable 109 and the number and arrangement of pulleys 113 operatively connected to the first block portion 115 and the second block portion 117. Actuation of the upward and downward motion of the base 107 and the load 101 is facilitated by retracting or deploying lift cable 123 from lift drive 121. Tension is maintained in the travel cable 109 and is provided by the weight of the suspended base 107 in the working space 108. Additionally, the tension in travel cable 109 provides a force on the second block portion 117 via the pulleys 113 operatively connected thereto, against which the lift cable 123 and lift drive 121 provide a force and allow the lift drive 121 to provide either an upward or downward motion along lift direction 119 to the second block portion 117.

Travel drive 125 and lift drive 121 are controlled by a controller 122 or control system. A suitable controller 122 or control system includes one or more microprocessors and graphical user interface that provides control to the travel drive 125 and lift drive 121 in response to the desired motion of base 107.

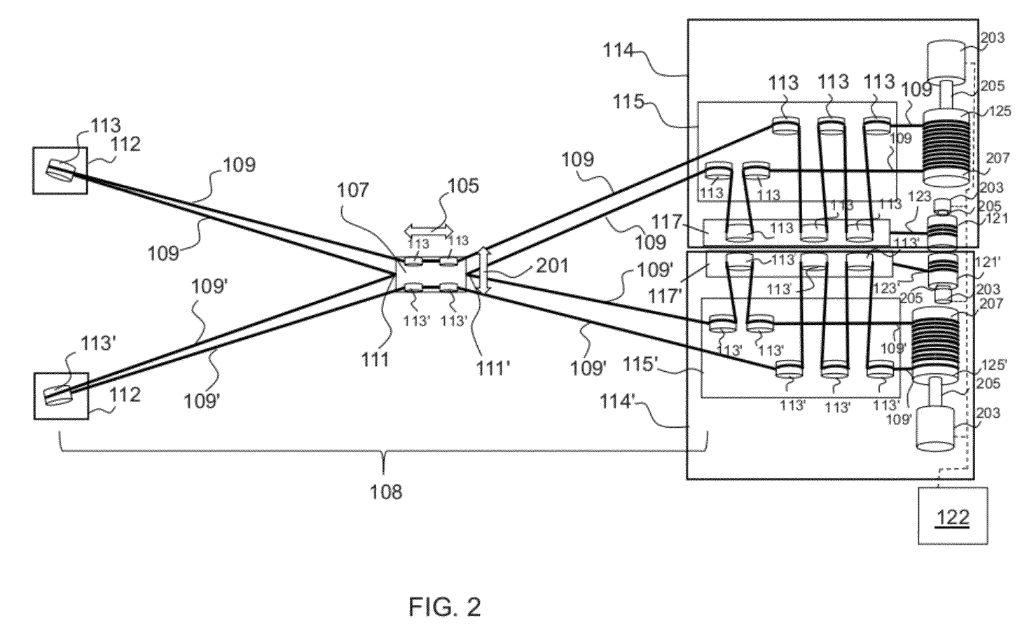

FIG. 2 shows a top view of an alternate arrangement of a multidimensional positioning system 100 that permits positioning in three dimensions. As shown in FIG. 2, one embodiment of the disclosure includes a lift drive 121 being a powered winch having a motor 203 attached to a shaft 205, which drives a reel 207. Shaft 205 may further included gearing, clutch assemblies, brakes, belts, chains or other structures useful for translating rotational motion from the motor 203 to rotational motion of the reel 207. In addition, reel 207 preferably includes a helical groove or similar structure to retain and drive travel cable 109. In addition, the arrangement of motor 203, shaft 205 and reel 207 are not limited to the arrangement shown in FIG. 2. Although the above has been described with respect to a lift cable 123 and lift drive 121 to move second block portion 117, other structures may be utilized to provide movement to second block portion 117. For example, second block portion 117 is moveable by a mechanical gearing system, by a motorized drive, by hydraulic cylinders, or by other actuation devices capable of moving second block portion 117. One embodiment of the disclosure includes a travel drive 125 being a powered winch having a motor 203 attached to a shaft 205, which drives a reel 207. The arrangement of motor 203, shaft 205 and reel 207 are substantially the same as the arrangement described above with respect to the lift drive 121. However, in the embodiment shown in FIGS. 1 and 2, the configuration of travel drive 125 includes a reel 207 configured in an endless configuration, wherein the cable retained on the reel 207 is retracted at one end of the reel 207 and deployed at another end of the reel 207.

In the embodiment shown in FIG. 2, in addition to first travel direction 103 (not visible in FIG. 2, see FIG. 1) and second travel direction 105 permitted by the embodiment shown in FIG. 1, the base 107 is capable of moving in an additional, third travel direction 201, which is shown, in this embodiment, as a lateral direction. Movement of the base 107 in the third travel direction 201 is facilitated by providing a first block assembly 114 and a second block assembly 114′. The first block assembly 114 includes a first block portion 115, a first travel drive 125, a second block portion 117, and a first lift drive 121. The second block assembly 114′ includes a first block portion 115′, a second block portion 117′, a second travel drive 125′, and a second lift drive 121′. The first block assembly 114 and second block assembly 114′ cooperatively and independently drive and manipulate a first travel cable 109 and a second travel cable 109′. The various components individually function and are arranged as shown and described with respect to FIG. 1, as identified as travel cable 109, above. In addition, the system 100 includes a base 107 attached and supported by both the first travel cable 109 and the second travel cable 109′, as shown and described with respect to FIG. 1, above. The first block assembly 114 and the second block assembly 114′ are preferably small, as described above, with respect to FIG. 1, as identified as identified as first block assembly 114 above, and may be arranged near each other, as shown in FIG. 2. In one embodiment, the first block assembly 114 and the second block assembly 114′ are arranged on the same truck or skid. In other embodiments, the first block assembly 114 and second block assembly 114′ may be mounted or arranged at opposite corners or opposite regions of a venue or at two or more distinct or predetermined locations or regions within the venue, as is desired for space or functionality.

The movement of base 107 along second travel direction 105 is provided by moving first travel cable 109 and second travel cable 109′ with first travel drive 125 and second travel drive 125′. The movement in first travel direction 103 (see FIG. 1), and third travel direction 201 are provided by the movement, such as upward or downward movement, of second block portion 117 of the first block assembly 114 relative to second block portion 117′ of the second block assembly 114′ in lift direction 119 (see also FIG. 1). That is, selective movement of one or both of second block portion 117 by first block assembly 114 relative to movement of second block portion 117′ by second block assembly 114′ results in selective movement of base 107 in first travel direction 103 and/or third travel direction 201. Stated another way, a selective rate and/or magnitude of length alteration of the second travel cable 109′ in the working space by the second lift drive 121′ relative to a selective rate and/or magnitude of length alteration of the first travel cable 109 in the working space by the first lift drive 121 results in selective movement of the base 107 in the first travel direction 103 and/or a third travel direction 201. The motor 203 in the first travel drive 125, the second travel drive 125′, the first lift drive 121, and the second lift drive 121′ are preferably independently controlled by a controller 122 or control system, as described above with respect to FIG. 1. For example, the base 107 may be moved upward in the first travel direction 103 if the first lift drive 121 and the second lift drive 121′ are selectably operated or actuated to move the second block portion 117 of the first block assembly 114 and the second block portion 117′ of the second block assembly 114′, respectively, downward in the lift direction 119. In addition, to provide movement in the lateral third travel direction 201, the first lift drive 121 and the second lift drive 121′ can be selectably operated or actuated to move the second block portion 117 of the first block assembly 114 and the second block portion 117′ of the second block assembly 114′, respectively, at different rates in the lift direction 119. For example, to move the base 107 in the third travel direction 201 toward the first block portion 115, the first lift drive 121 and the second lift drive 121′ move the second block portion 117 of the first block assembly 114 and the second block portion 117′ of the second block assembly 114′, respectively, downward such that the amount of displacement for the second block portion 117′ in the lift direction 119 is less than the displacement for the second block portion 117 of the first block assembly 114. The combination of the movement in the second travel direction 105, the movement in the first travel direction 103 and the third travel direction 201 permits movement and positioning of a load in three dimensions within the working space 108.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A multidimensional positioning system comprising;
a first block assembly comprising a fixed first block portion and a moveable second block portion;
a first travel cable arranged on pulleys operatively connected to the first block portion, the second block portion and a predetermined location, the first travel cable further affixed to a base supporting a load;
a first travel drive operatively connected to the first travel cable to facilitate movement of the base in a second travel direction; and
a first lift drive arranged and disposed to provide movement of the second block portion relative to the first block portion to selectively alter the length of the first travel cable in a working space and selectively move the base in a first travel direction.

2. The system of claim 1, further comprising:
a second block assembly comprising a fixed first block portion and a moveable second block portion;
a second travel cable arranged on pulleys operatively connected to a predetermined location and also connected to the first block portion and the second block portion of the second block assembly, the second travel cable further affixed to the base supporting the load;
a second travel drive operatively connected to the second travel cable to facilitate movement of the base in the second travel direction; and
a second lift drive arranged and disposed to provide movement of the second block portion relative to the first block portion of the second block assembly to selectively alter the length of the second travel cable in the working space; and
wherein a selective rate and/or magnitude of length alteration of the second travel cable in the working space by the second lift drive relative to a selective rate and/or magnitude of length alteration of the first travel cable in the working space by the first lift drive results in selective movement of the base in the first travel direction and/or a third travel direction.

3. The system of claim 2, wherein the first travel drive and the second travel drive are independently operable of each other.

4. The system of claim 2, wherein the first lift drive and the second lift drive are independently operable of each other.

5. The system of claim 1, wherein the distance between the first portion and the predetermined location is greater than 100 feet.

6. The system of claim 1, wherein the distance between the first portion and the predetermined location is greater than 500 feet.

7. The system of claim 1, wherein the distance between the first portion and the predetermined location is greater than 1000 feet.

8. The system of claim 1, wherein the distance between the first portion and the predetermined location is greater than 2500 feet.

9. The system of claim 1, wherein at least one pulley operatively connected to the base, the predetermined location, the first block portion or the second block portion is a free-rolling pulley.

10. The system of claim 1, wherein at least one pulley operatively connected to the base, the predetermined location, the first block portion or the second block portion is provided with a rotation facilitating and/or rotation retarding device.

11. The system of claim 1, wherein the predetermined location is a support structure.

12. The system of claim 2, wherein the first lift drive and the second lift drive are endless/friction rotation drives.

13. The system of claim 2, wherein the first block assembly and the second block assembly are arranged near each other.

14. The system of claim 2, wherein the first block assembly and the second block assembly are arranged at opposite regions of a venue.

15. The system of claim 2, wherein the first block assembly and the second block assembly are arranged at predetermined regions of a venue.

16. The system of claim 2, wherein both the second block portion of the first block assembly is movable relative to the first block portion of the first block assembly, and the second block portion of the second block assembly is movable relative to the first block portion of the second block assembly along a lift direction.

17. The system of claim 16, wherein the lift direction is oriented in generally the same direction as the first travel direction of the base.

18. A multidimensional positioning block assembly comprising:
a first block assembly and a second block assembly each comprising a fixed first block portion and a moveable second block portion;
a first travel cable arranged on pulleys operatively connected to the first block portion of the first block assembly, the second block portion of the first block assembly, and a predetermined location, the first travel cable further affixed to a base supporting a load;
a second travel cable arranged on pulleys operatively connected the first block portion of the second block assembly, the second block portion of the second block assembly, and the predetermined location, the second travel cable further affixed to the base supporting the load;
a first lift drive arranged and disposed to provide movement of the second block portion of the first block assembly relative to the first block portion of the first block assembly to selectively alter the length of the first travel cable in a working space and selectively move the base in a first travel direction.
a second lift drive arranged and disposed to provide movement of the second block portion of the second block assembly relative to the first block portion of the second block assembly to selectively alter the length of the second travel cable in the working space; and
wherein a selective rate and/or magnitude of length alteration of the second travel cable in the working space by the second lift drive relative to a selective rate and/or magnitude of length alteration of the first travel cable in the working space by the first lift drive results in selective movement of the base in the first travel direction and/or a third travel direction.

19. A method for providing multidimensional positioning comprising:
providing a first block assembly comprising a fixed first block portion and a moveable second block portion;
providing a first travel cable arranged on pulleys operatively connected to the first block portion, the second block portion and a predetermined location, the first travel cable further affixed to a base supporting a load;
providing a first travel drive operatively connected to the first travel cable to facilitate movement of the base in a second travel direction; and
providing a first lift drive arranged and disposed to provide movement of the second block portion relative to the first block portion;
selectively actuating the first travel drive to selectively alter the length of the first travel cable in a working space and selectively move the base in a first travel direction; and
selectively actuating the first lift drive.

20. The method of claim 19, comprising:
providing a second block assembly comprising a fixed first block portion and a moveable second block portion;
providing a second travel cable arranged on pulleys operatively connected to a predetermined location and also connected to the first block portion and the second block portion of the second block assembly, the second travel cable further affixed to the base supporting the load;
providing a second travel drive operatively connected to the second travel cable to facilitate movement of the base in the second travel direction;
providing a second lift drive arranged and disposed to provide movement of the second block portion relative to the first block portion of the second block assembly to selectively alter the length of the second travel cable in the working space, wherein a selective rate and/or magnitude of length alteration of the second travel cable in the working space by the second lift drive relative to a selective rate and/or magnitude of length alteration of the first travel cable in the working space by the first lift drive results in selective movement of the base in the first travel direction and/or a third travel direction;
selectively actuating the second lift drive relative to the first lift drive; and
selectively actuating the second travel drive relative to the first travel drive.
